(19) United States
(12) Patent Application Publication
(10) Pub. No.: US 2005/0178343 A1
(43) Pub. Date: Aug. 18, 2005

(54) Dog tug toy and method of manufacture

(76) Inventor: Amy Lubeck, Oregon, WI (US)

Correspondence Address: Peter N. Jansson;Jansson, Shupe & Munger, Ltd., 245 Main Street, Racine, WI, 53403, US

(21) Appl. No.: 10/955,725

(22) Filed: Sep. 29, 2004

Related U.S. Application Data
(60) Provisional application No. 60/507,199, filed on Sep. 29, 2003.
(60) Provisional application No. 60/507,198, filed on Sep. 29, 2003.

(51) Int. Cl. A01K 29/00

(52) U.S. Cl. 119/709

(57) ABSTRACT

A dog tug toy including a ball or other biting object on a rope, the biting object having a rope opening into its interior cavity and the attachment involving a complex of knots formed inside the biting object. A method for making such dog tug toy including a sequence of knot-forming and insertion steps.

### RELATED APPLICATIONS

This application is based in part on U.S. Provisional Application No. 60/507,199, filed Sep. 29, 2003, the contents of which are incorporated herein by reference, and on U.S. Provisional Application No. 60/507,198, filed Sep. 29, 2003, the contents of which are incorporated herein by reference.

### FIELD OF THE INVENTION

This invention relates in general to toys for pets and, more particularly, to dog tug toys of the type having a rope attached to a ball.

### BACKGROUND OF THE INVENTION

Dog toys provide a means for enjoyment and exercise for dogs (and other pets). As is well known, balls and other pet toys which can bounce and be pounced upon and grabbed by a pet's mouth are very popular. Dogs love chasing and retrieving such bouncing toys. Tug toys have proved to be very popular with dogs and their owners, not only for fun but to provide beneficial exercise for dogs. Especially favorite dog toys are those having a ball (or other object) attached to a rope to be held by a person and tugged by a pet. For convenience these are referred to herein as “dog tug toys.”

Currently, the balls of dog tug toys are attached to their pulling ropes in one of two ways. Either the rope passes through holes on opposite sides of the ball and is held by a knot outside the ball or the rope is actually looped through the ball and tied. Either way, a number of problems occur.

First, the knot outside the ball of a dog tug toy has a tendency to cause a dog to gag—because the knot extends too far into the dog's mouth. This problem, recognized by dogs, prompts them to bite the ball in a sideways fashion. This can be a frustration both for dogs and for their owners during play with dog tug toys. Second, in some cases, particularly with dog tug toys that have a knot on one side of the ball and do not include a loop, the rope is not well enough secured to the ball and detaches from it when pulled hard. Third, dogs have strong jaws and an instinct to pull upon and chew their toys; therefore, many balls with insufficient strength and inadequate rope-ball attachment suffer extensive damage from dogs and are easily destroyed.

In the field of pet toys, there is a need for a gag-free dog tug toy with strong rope-ball attachment, particularly using tough balls such as tennis balls, which are highly preferred by dogs. The present invention is a result of research efforts concerning these problems and development efforts on products to overcome such problems.

### OBJECTS OF THE INVENTION

It is an object of the invention to provide an improved dog tug toy overcoming problems and shortcomings of prior dog tug toys, including the problems mentioned above.

Another object of this invention is to provide a dog tug toy having secure loop-free, gag-free rope-ball attachment.

Another object of this invention is to provide a dog tug toy eliminating knots outside the ball in position to cause gagging by dogs.

A further object of the present invention is to provide a dog tug toy which reliably secures a rope to a ball with a knot or complex of knots positioned within the ball—i.e., a knot or complex of knots which are large enough that the rope cannot be pulled out of the ball.

Another key object of the present invention is to provide a method for making dog tug toys with improved rope-ball attachment.

Still another object of the invention is to provide a dog tug toy having the above advantages and also including the attractive feature of giving a squeaking response to the biting action of a dog.

How these and other objects are accomplished will become apparent from the following descriptions and the drawings.

### SUMMARY OF THE INVENTION

This invention, which will be described in detail below, is an improvement in dog tug toys of the type including a ball or other biting object for a dog to bite attached to a rope for a person to hold.

The present invention provides a dog tug toy and a method of manufacture overcoming the problems described above. It substantially eliminates the problem of gagging. It strongly resists detachment of the ball from the rope, even when subjected to intense treatment by dogs and their owners. Furthermore, the dog tug toy of this invention is made out of material which is resilient but strong enough so the toy can function for a long time in spite of considerable abuse by the dog and the owner.

In the inventive dog tug toy, the biting object has a hollow interior cavity and a tough outer surface defining a rope opening into the cavity, and the rope has first and second end portions, the first end portion extending into the cavity through the rope opening, terminating at an end within the cavity, and secured therein by a complex of knots in the first end portion in the cavity. The biting object preferably has a tennis-ball-like outer surface, and is most preferably a tennis ball. Throughout this summary section and elsewhere in this specification, this invention will refer to the biting object as a “ball” or “tennis ball”; however, it is to be understood that the invention is not limited in scope by the exact nature of the biting object.

The complex of knots inside the ball is large enough that it cannot be pulled out of the ball apart from monumental force not typically achievable by the largest dogs and the strongest owners. Furthermore, the nature of this attachment eliminates any external knot which a dog could gag.

In some preferred embodiments, the complex of knots is a complex knot formed by at least two joined single knots, each in the entirety of the rope.

In certain preferred embodiments, the rope is formed by at least two strands. In the first end portion, the strands of the rope are separated, and the complex of knots includes at least one knot in each of at least two of the separated strands. In preferred cases, the complex of knots includes at least one knot in each of at least three of the separated strands. The knots are preferably positioned on the strands substantially equidistant from the first end of the rope, because this facilitates formation of a complex of knots of substantial cross-dimension, thus better preventing the complex of knots from being pulled out though the rope opening.

In certain preferred embodiments, the second end portion of the rope is tied into a loop for a handle. In certain highly preferred embodiments of this type, an additional ball is secured on the loop of the handle. In some embodiments involving a loop for a handle, the rope has a mid-portion between the first and second end portions and the mid-portion has an additional ball secured thereto; in certain of such embodiments the mid-portion of the rope passes through the additional ball.

Certain special preferred embodiments further include at least one squeaker device within the ball cavity. This provides a squeaking response to a dog's biting of the ball, and further uses the tough ball as a means of protecting the squeaker device from destruction from a dog's teeth.

One preferred embodiment of this invention includes a second tennis ball (or other biting object) like the first, attached to the other end of the rope in the same manner as is used for attachment of the first ball to the first end of the rope. In certain of such preferred embodiments, the rope has a mid-portion between the first and second end portions, the mid-portion having a handle thereon, thereby allowing two balls to be controlled easily by one hand. In some of such embodiments, the handle is a loop formed in the mid-portion of the rope.

Another important aspect of this invention involves a method for making a dog tug toy of the type disclosed above. The inventive method includes: forming a rope opening into the hollow interior cavity of the ball; tying a first single knot in a first end portion of the rope; pushing the first single knot into the ball through the rope opening; tying a second single knot in the first end portion of the rope; and pushing the second single knot into the ball through the rope opening such that the single knots form a complex of knots, whereby the complex of knots is of sufficient size such that the rope remains secured to the ball despite tugging force. The ball is preferably a tennis ball.

In certain preferred examples of the method of this invention, the first single knot is tied in the entirety of the rope, such first single knot being spaced from the end of the rope. The pushing of the first single knot into the ball is done in a manner leaving both ends of the rope outside the ball. Then, the second single knot is tied in the entirety of the rope outside the ball at the outer surface thereof, such knot being tied using portions of the rope outside the ball and extending from either side of the first single knot. Then, the pushing of the second single knot into the ball is accompanied by pushing the first end of the rope into the ball, and thereafter the remaining portion of the rope is pulled in a direction away from the ball so that the two single knots inside the ball joined together as a double knot inside the ball. In such preferred method, it is preferred that the first single knot be tied at a position within about six inches from the first end of the rope.

In certain highly preferred examples of the method of this invention, the rope is formed by at least two strands and a preliminary step is separating the strands in the first end portion of the rope. After separating the strands in the first end portion of the rope, the first single knot is tied in one of the separated strands, and such strand and knot are pushed into the ball, leaving at least one of the other separated strands outside the ball. Then, the second single knot is tied in a separated strand that is outside the ball, after which such strand and knot are pushed into the ball. The first and second single knots are adjacent to one another within the ball to form the complex of knots inside the ball. A particularly preferred form of the method repeats the same steps for the third strand. Note that it is not essential that the number of single knots tied in strands equal the number of strands; any strands without knots should also be pushed into the ball.

Some preferred examples of the method of this invention also include tying the second end portion of the rope into a loop for the handle. Some preferred examples involve inserting a squeaker body into the ball.

As used herein, the term “tennis-ball-like surface,” in reference to biting objects, refers to surfaces of a tough rubber or rubber-like material that has a felt or felt-like cover. Such biting objects and bodies are known to be able to withstand repetitive biting by dogs without incurring significant damage.

As used herein, the term “tough outer surface” means that the material forming the ball or other biting object has a toughness character sufficient such that repetitive frequent biting by a typical dog over an extended period (a month or more) will not puncture the ball or other biting object. Toughness typical of a tennis ball more than satisfies this requirement.

As used herein, the term “strand” refers to a complex of fibers a plurality of which form a common type of rope. In many common forms of rope, strands are twisted together to form the rope; in some cases, the rope is formed by the braiding of strands.

As used herein, the term “entirety of the rope” refers to whole cross-section of the rope, with all its strands together.

### BRIEF DESCRIPTION OF THE DRAWINGS

FIG. 1 is a perspective view of a dog tug toy in accordance with a preferred embodiment of the invention.

FIG. 2 is a top plan view of the tennis ball of the dog tug toy of FIG. 1, showing the rope opening drilled in the hollow ball.

FIG. 3 is a perspective view of a first end portion of the rope of the dog tug toy of FIG. 1, with a single knot tied in the entirety of the rope near the first end of the rope.

FIGS. 4A, 4B and 5 are perspective views with the ball in section in FIGS. 4B and 5, illustrating the position of the single knot as it approaches and is then pushed into the tennis ball through the rope opening seen best in FIG. 2.

FIG. 6 is another perspective view with the ball in section, illustrating the tying of a second knot in the entirety of the rope outside the ball at the outer surface thereof.

FIG. 7 is another perspective view with the ball in section, illustrating the complex (double) knot inside the ball resulting from insertion of the second knot of FIG. 6 from a position outside the ball to a position inside the ball, in engagement with the first knot, as well as insertion of the first end of the rope into the ball.

FIG. 8 is another perspective view with the ball in section, illustrating the tying of the remaining portion of the rope, outside the ball, into a loop to form a handle.

FIG. 9 is a perspective view of a first end portion of the rope of the dog toy of FIG. 1, illustrating separated strands of the rope with at least one knot in each of the separated strands.

FIG. 10 is a perspective view of a first end portion of the rope of FIG. 13, illustrating the first single knot tied in individual strand pushed inside the ball.

FIG. 11 is a perspective view of a first end portion of the rope of FIG. 13, illustrating two single knots pushed inside the ball to form a complex of knots.

FIG. 12 is a perspective view of the ball secured to the first end portion of the rope of FIG. 9.

FIG. 13 is a perspective view of an alternative embodiment having a second ball attached to a second end of the rope in a fashion similar to the attachment used at the first end of the rope.

FIG. 14 is a perspective view of another embodiment having a second ball secured on the rope between the first ball and the handle loop.

FIG. 15 is a perspective view of another embodiment having a second ball on the handle.

FIG. 16 is a partially sectional perspective view of an embodiment including a squeaker device in the ball along with the complex knot.

### DETAILED DESCRIPTION OF PREFERRED EMBODIMENTS

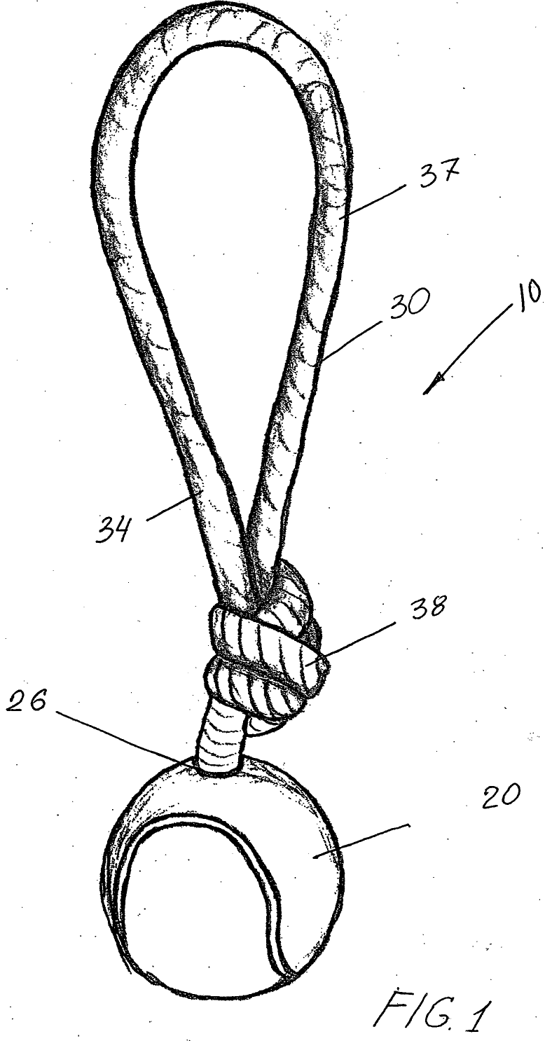

Referring to FIGS. 1-8, a unique dog tug toy 10 and its unique method of manufacture are illustrated. Dog tug toy 10 includes a tennis ball 20 and a rope 30. Tennis ball 20 has a hollow interior cavity 22 and a tough felt outer surface 24 defining a rope opening 26. Rope 30 has a first end portion 32 by which it is attached to ball 20, as hereafter described, and a second end portion 34 which forms a loop 37 by tying a loop-forming knot 38.

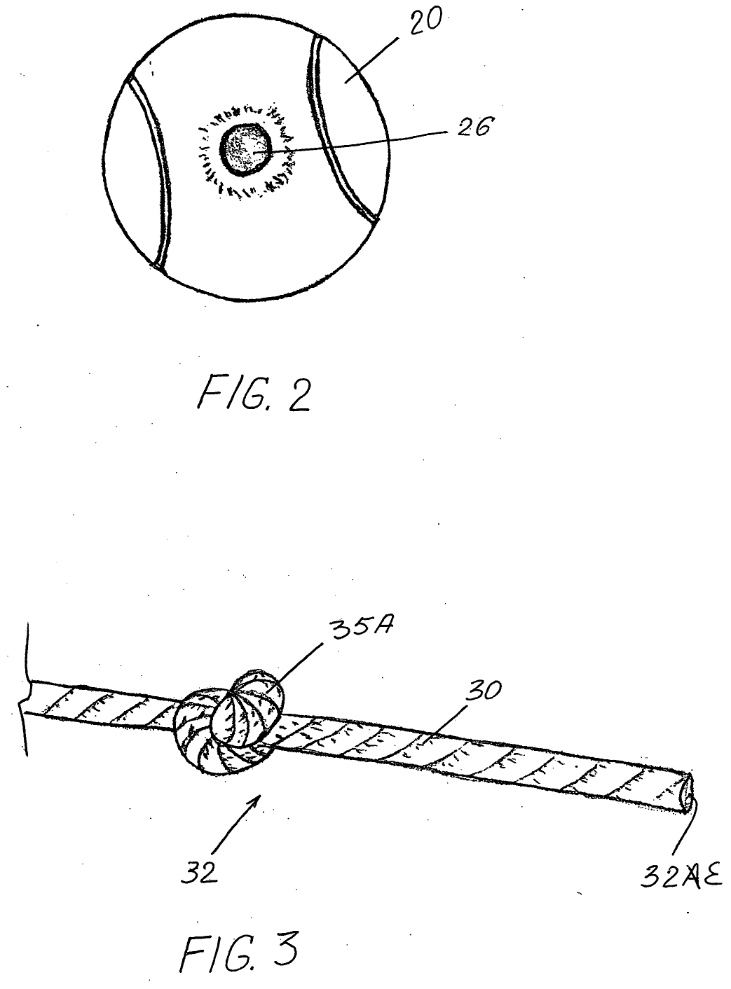

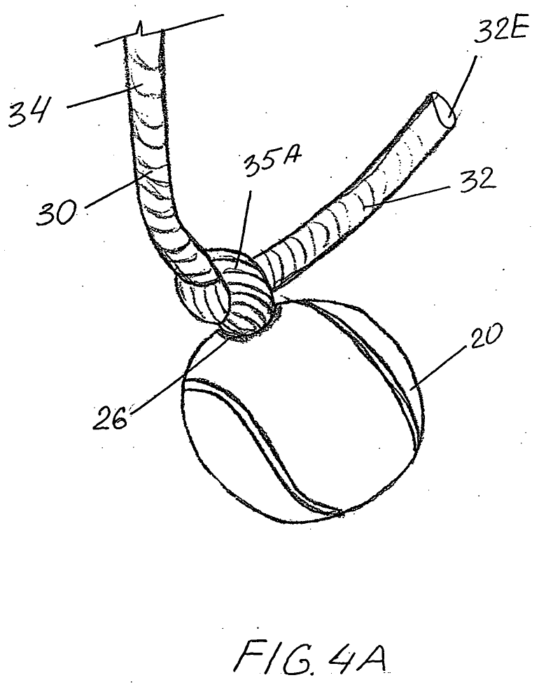

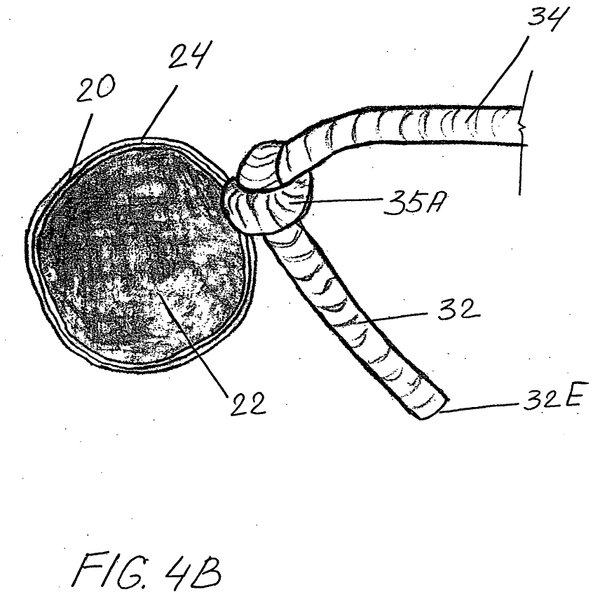

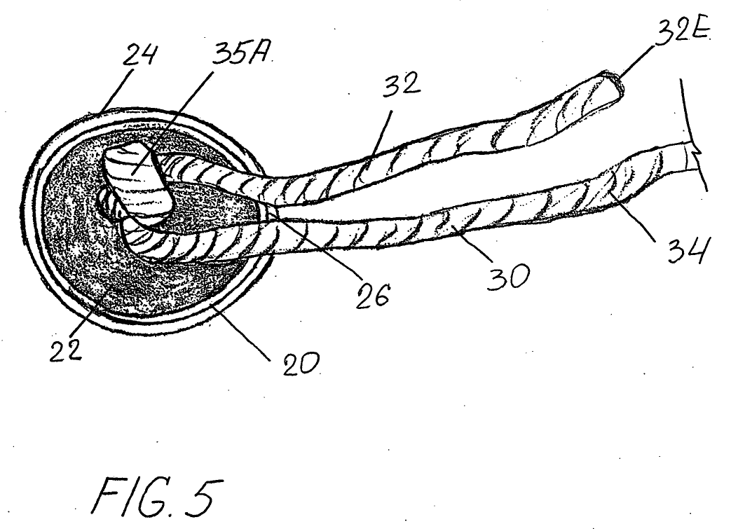

Dog tug toy 10 is manufactured by a unique method which allows a complex of knots of substantial size to be formed inside ball 20. After a rope opening 26 is drilled in ball 20 (see FIG. 2), several knot-forming and stuffing steps are taken to create the complex of knots inside ball 20. These steps are as follows: A first single knot 35A is tied in the entirety of rope 30 in first end portion 32 of rope 30 at a position approximately 6 inches from the end 32A of rope 30 (see FIG. 3). First single knot 35A is then pushed into interior cavity 22 through rope opening 26 leaving the remaining end of first end portion 32 outside ball 20 (see FIGS. 4A, 4B and 5). Then both free portions of rope 30 protruding from ball 20 are tied in their entirety into a second single knot 35B very close to outer surface 24 of ball 20 at rope opening 26 (see FIG. 6). Next, both second single knot 35B and first end 32A of rope 30 are pushed into cavity 22 through rope opening 26.

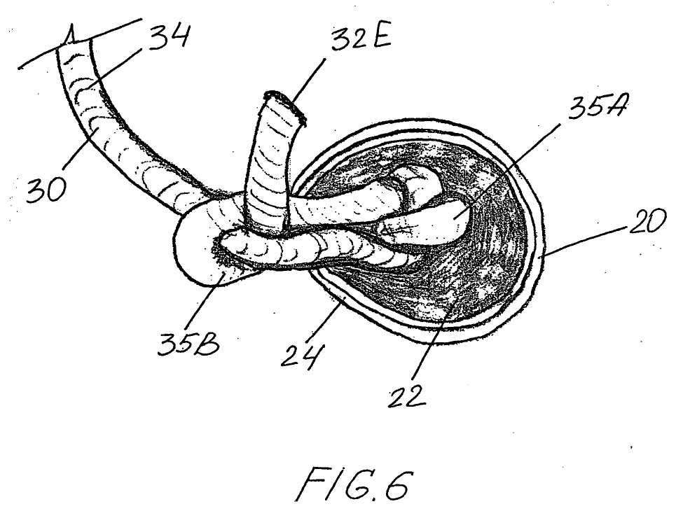

The rope-ball attachment is then completed to form a complex knot within cavity 22 in the following manner: The single length of rope now protruding from ball 20 is manually pulled in a direction away from ball 20 while the puller grips ball 20 about rope opening 26 to prevent the not-yet-joined first and second single knots 35A and 35B from exiting the ball through rope opening 26. This causes the single knots to come together into a complex knot 35 (see FIG. 7), which is significantly larger than either single knot—and, in fact, is large enough such that it cannot, for all practical purposes, be pulled out of ball 20. Thus, a rope-ball connection is formed which is highly strong and reliable and yet does not have an external knot of the sort which can cause dogs to gag when biting the ball.

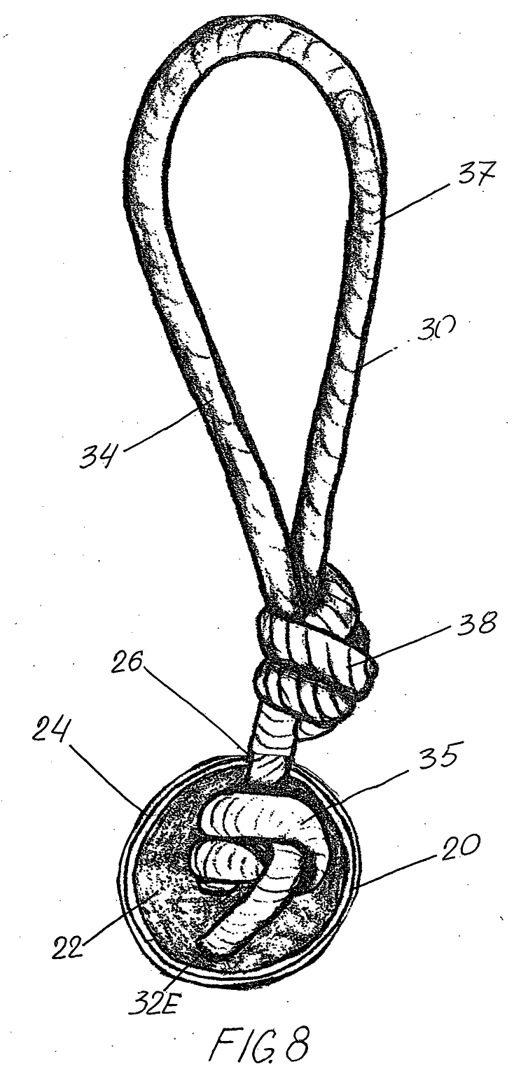

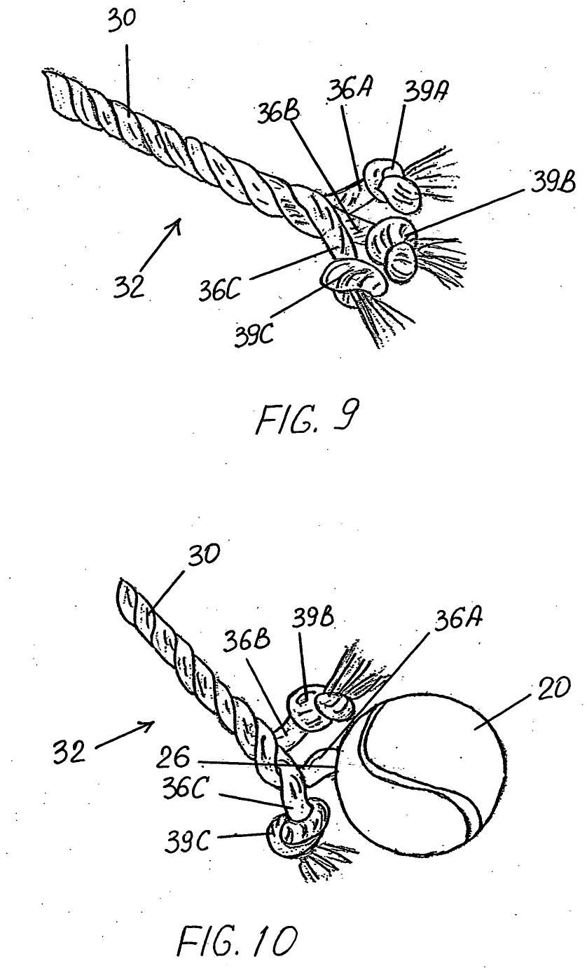

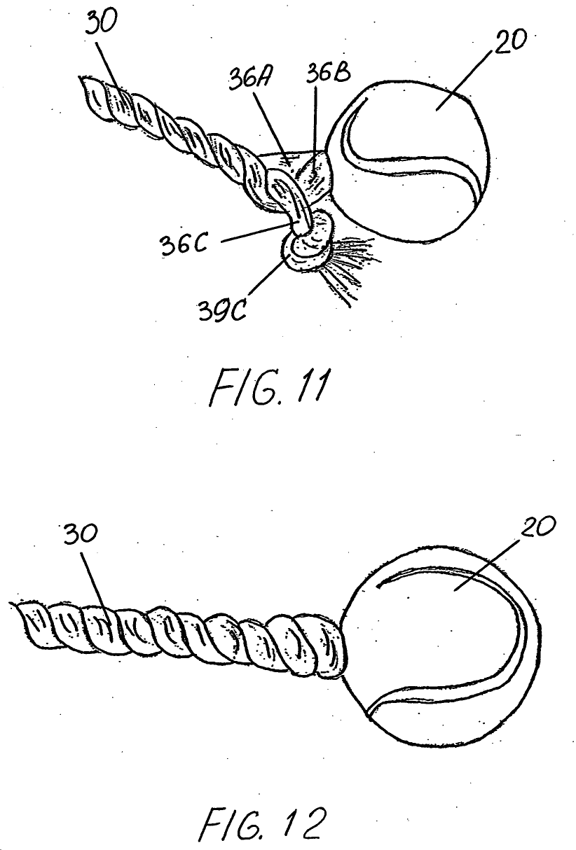

In alternative embodiments of this invention, rope 30 is formed by at least two strands 36, and a preliminary step is separating strands 36 in first end portion 32 of rope 30. The knots are tied in individual strands 36 and are positioned substantially equidistant from end 32E of first end portion 32 of rope 30 (see FIG. 9.) The knot-forming and stuffing steps for this alternative embodiment are as follows: A first single knot 39A is tied in separated strand 36A. First single knot 39A is then pushed into interior cavity 22 through rope opening 26, along with the end of such strand, leaving separated strands 36B and 36C outside ball 20 (see FIG. 10). A second single knot 39B is tied in separated strand 36B, which is outside ball 20 and pushed into ball 20 thought rope opening 26. In the same way, a third single knot 39C is tied in strand 36C and pushed into ball 20 thought rope opening 26. After single knots 39B and 39C pushed into ball 20 along with the respected strand ends, such single knots are adjacent to one another to form a complex of knots 39 inside ball 20 (see FIGS. 11-12). Complex of knots 39 is of sufficient size such that rope 30 remains secured to ball 20, despite tugging force.

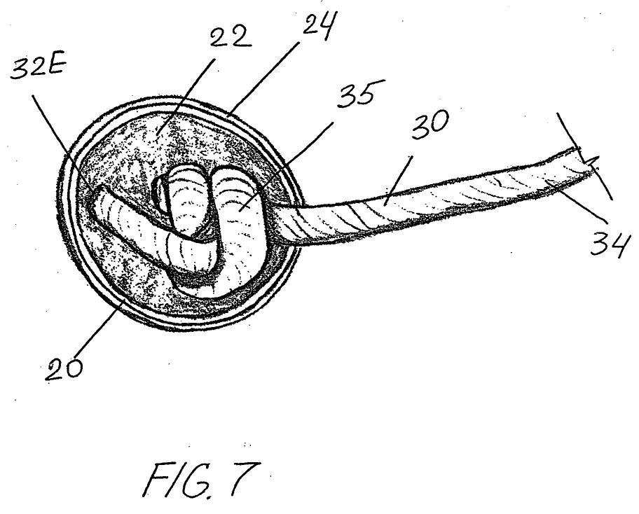

Dog tug toy 10 is completed by forming a loop 37 to serve as a handle to be held by the dog's owner during play. (See FIGS. 1 and 8).

The embodiment illustrated in FIG. 16 is identical to the embodiment of FIGS. 1-8 except that a squeaker device 40 is also inserted into hollow interior cavity 22 of ball 20. As is known, a squeaker device is a resilient air-containing bladder which has an air tube that causes a squeak (whistle) when squeezed. Included as it is in dog tug toy 10, squeaker device 40 provides additional stimulation for the dog during play, making the toy more exciting and attractive to use.

FIGS. 13-15 illustrate other embodiments of the invention, each including at least one rope-ball connection which is of the type described above. Each such embodiment includes a second ball. These embodiments are designed to suit the preferences of dog owners with respect to the particular form of a dog tug toy.

Referring to FIG. 13, a second ball 50 is attached to the end of second end portion 34 of rope 30 in the same attachment manner as used for first ball 20. The mid-portion 33 of rope 30, between first end portion 32 and second end portion 34, is tied into a loop 37A to form a handle.

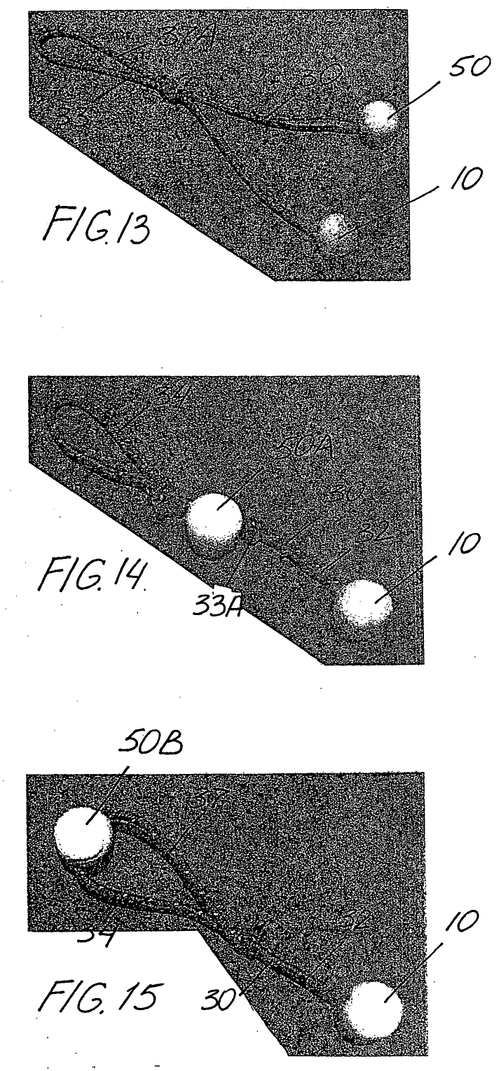

Referring to FIG. 14, a second ball 50A is secured on mid-portion 33 of rope 30 between ball 20 (on first end portion 32) and a handle loop formed in second end portion 34. Mid-portion 33 of rope 30 passes through two opposed rope openings in second ball 50A. A knot 33A is tied in mid-portion 33 of rope 30 to maintain second ball 50A in place.

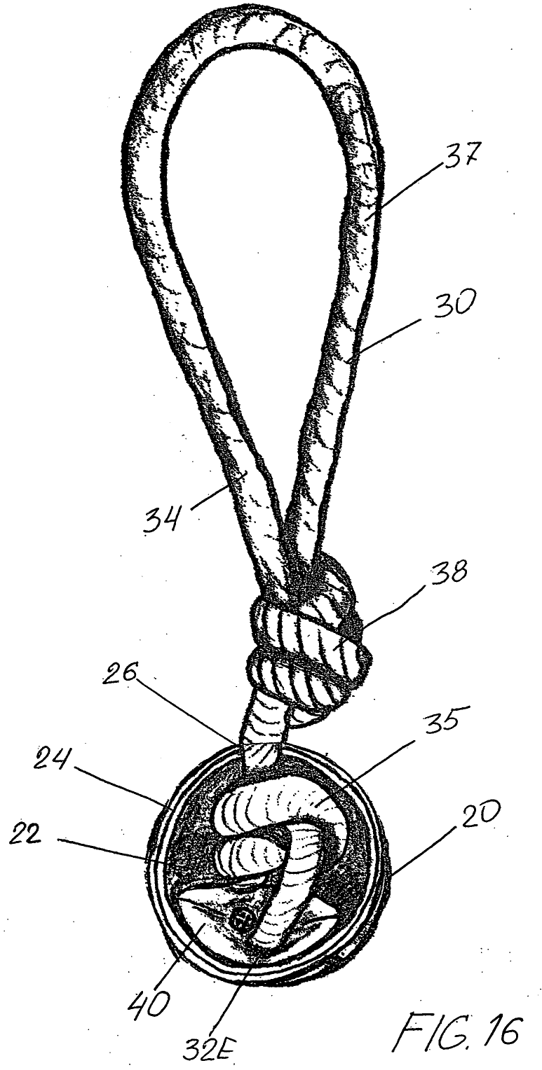

Referring to FIG. 15, a secondary ball 50B is secured on handle loop 37 by a portion of such loop passing through two opposed rope openings in ball 50B.

Many other variations within the scope of the invention are possible. Many choices will be available to those skilled in the art who are made aware of the nature of this invention.

While the principles of the invention have been shown and described in connection with specific embodiments, it is to be understood that such embodiments are by way of example and are not limiting.

1. In a dog tug toy of the type including a biting object for a dog to bite attached to a rope to be held by a person, the improvement wherein:
the biting object has a hollow interior cavity and a tough outer surface defining a rope opening into the cavity; and
the rope has first and second end portions, the first end portion extending into the cavity through the rope opening, terminating at an end within the cavity, and secured therein by a complex of knots in the first end portion in the cavity.

2. The dog tug toy of claim 1 wherein the biting object has a tennis-ball-like outer surface.

3. The dog tug toy of claim 2 wherein the biting object is a tennis ball.

4. The dog tug toy of claim 2 wherein the complex of knots is a complex knot formed by at least two joined single knots, each in the entirety of the rope.

5. The dog tug toy of claim 2 wherein:
the rope is formed by at least two strands;
1in the first end portion, the strands of the rope are separated; and
the complex of knots includes at least one knot in each of at least two of the separated strands.

6. The dog tug toy of claim 2 wherein the knots are positioned on the strands substantially equidistant from the first end of the rope.

7. The dog tug toy of claim 5 including at least one knot in each of at least three of the separated strands.

8. The dog tug toy of claim 2 wherein the second end portion of the rope is tied into a loop for a handle.

9. The dog tug toy of claim 8 wherein an additional biting object is secured on the loop of the handle.

10. The dog tug toy of claim 9 wherein the rope has a mid-portion between the first and second end portions, the mid-portion having yet another biting object secured thereto.

11. The dog tug toy of claim 10 wherein the mid-portion of the rope passes through the biting object secured to the mid-portion.

12. The dog tug toy of claim 2 further comprising at least one squeaker device within the cavity.

13. The dog tug toy of claim 2 further comprising:
a second biting object with a tennis-ball-like outer surface and having a hollow interior cavity and a tough outer surface defining a rope opening into the cavity of the second biting object; and
the second end portion extends into the cavity of the second biting object through its rope opening, terminates at an end within such cavity, and is secured therein by a complex of knots in the second end portion in the cavity of the second biting object.

14. The dog tug toy of claim 13 wherein the complex of knots in the second biting object is a complex knot formed by at least two joined single knots in the second end portion in the cavity, each of the single knots being in the entirety of the rope.

15. The dog tug toy of claim 13 wherein:
the rope is formed by at least two strands;
in the first end portion, the strands of the rope are separated, and the complex of knots in the first end portion includes at least one knot in each of at least two of the separated strands of the first end portion;
in the second end portion, the strands of the rope are separated, and the complex of knots in the second end portion includes at least one knot in each of at least two of the separated strands of the second end portion.

16. The dog tug toy of claim 16 wherein the knots in the strands of each of the first and second end portions are positioned on the strands substantially equidistant from the respective end of the rope.

17. The dog tug toy of claim 15 including at least one knot in each of at least three of the separated strands of each of the first and second end portions.

18. The dog tug toy of claim 15 wherein the rope has a mid-portion between the first and second end portions, the mid-portion having a handle, thereby allowing two balls to be controlled by one hand.

19. The dog tug toy of claim 18 wherein the handle is a loop formed in the mid-portion.

20. In a method for making a dog tug toy of the type including a biting object for a dog to bite attached to a rope to be held by a person, the improvement comprising:
forming a rope opening into the hollow interior cavity of the biting object;
tying a first single knot in a first end portion of the rope;
pushing the first single knot into the biting object through the rope opening;
tying a second single knot in the first end portion of the rope; and
pushing the second single knot into the biting object through the rope opening such that the single knots form a complex of knots,
whereby the complex of knots is of sufficient size such that the rope remains secured to the biting object despite tugging force.

21. The method of claim 20 wherein:
the first single knot is tied in the entirety of the rope, such first single knot being spaced from the end of the rope;
the pushing of the first single knot into the biting object leaves both ends of the rope outside the biting object;
the second single knot is tied in the entirety of the rope outside the biting object at the outer surface thereof; and
the pushing of the second single knot into the biting object is accompanied by pushing the first end of the rope into the biting object; and
including the further step of:
pulling the remaining portion of the rope in a direction away from the biting object to join the single knots as a double knot inside the biting object.

22. The method of claim 21 wherein the first single knot is tied at a position within about six inches from the first end.

23. The method of claim 20 wherein the rope is formed by at least two strands and a preliminary step is separating the strands in the first end portion of the rope, and wherein:
the first single knot is tied in one of the separated strands;
the pushing of the first single knot into the biting object leaves at least one of the other separated strands outside the biting object;
the second single knot is tied in a separated strand remaining outside the biting object; and
after the pushing of the second single knot into the biting object, the first and second single knots are adjacent to one another to form the complex of knots inside the biting object.

24. The method of claim 20 wherein the biting object is a tennis ball.

25. The method of claim 24 including tying the second end portion of the rope into a loop for the handle.

26. The method defined in claim 24 including inserting a squeaker body into the ball.

27. In a dog tug toy of the type including a biting object for a dog to bite attached to a rope to be held by a person, the improvement wherein:
the biting object has a hollow interior cavity and a tough outer surface defining a rope opening into the cavity; and
the rope has first and second end portions, the first end portion extending into the cavity through the rope opening, terminating at an end within the cavity, and secured therein by a knot in the first end portion in the cavity.

28. The dog tug toy of claim 27 wherein the biting object is a tennis ball.

29. The dog tug toy of claim 27 further comprising at least one squeaker device within the cavity.
